(19) United States
(12) Patent Application Publication
(10) Pub. No.: US 2005/0120862 A1
(43) Pub. Date: Jun. 9, 2005

(54) Apparatus and method for practicing drumming

(76) Inventor: Theodore George Frazier, Denver, CO (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 10/824,293

(22) Filed: Apr. 14, 2004

Related U.S. Application Data
(60) Provisional application No. 60/526,516, filed on Dec. 3, 2003.

(51) Int. Cl. G10D 13/02

(52) U.S. Cl. 84/411 R

(57) ABSTRACT

An apparatus for practicing drumming and a method of practicing drumming are described. Preferred embodiments of the apparatus comprise an elastic cord tensioned between two support arms that lessen the impact load transferred back to the drummer's hands and arms when stuck by a drumstick as compared to prior art drumming practice pads.

### REFERENCE TO RELATED APPLICATIONS

This application claims priority to and incorporates herein in its entirety the provisional application No. 60/526,516 filed on Dec. 3, 2003 entitled “Drum practice and warm up device and method of practice”, and having the same inventor as this application.

### FIELD OF THE INVENTION

This invention generally relates to musical instruments. More particularly, this invention pertains to an apparatus for practicing drumming.

### BACKGROUND

As is the case with all musicians, drummers must constantly practice in order to improve and maintain their skills. Furthermore, practicing drumming is necessary for the drummer to build up sufficient strength in his/her fingers, hands, wrists and forearms to permit the drummer to play for extends periods without undue fatigue. However, practicing drumming on drums can be extremely loud typically limiting a drummer to practicing on his/her drum set to times when other people are not around. Accordingly, the ability to practice on a device or apparatus that produces relatively low intensity sound and is less annoying to other persons within the vicinity is often the only practical means of practicing.

A variety of drumming practice devices exist. The most typical of these devices comprise practice pads. Simply, practice pads comprise a rubber pad mounted on a base. By repeatedly striking the practice pad with the drumsticks using well known rudiments, the drummer increases his/her muscle control and strength. Further, the sound produced by the impact of the sticks with the practice pad is significantly deadened by the rubber pad such that the sound does not carry very far and a user can practice in a room without annoying or bothering other occupants located elsewhere in a house.

Several practice pad variations are described in United States patents. U.S. Pat. No. 5,929,354 to Davis describes the use of a pad made of silicone rubber. U.S. Pat. No. 3,186,290 depicts a pad having a layered arrangement.

In order to make a practice pad with an amount of stick rebound after the pad has been hit that approximates that of a drum, relatively dense rubber pad is utilized. Foams have typically been found to offer insufficient rebound as they absorb much of a stick's impact energy and/or do not elastically return the energy quickly enough. Unfortunately, the denser rubber pads do not deform substantially when struck causing the head of the stick to more quickly decelerate and transfer the resulting higher magnitude impact load through the stick and into the user's hand and forearm. During a practice session wherein a drummer sticks the practice pad thousands of time, the cumulative effect of increased load transfer can more quickly fatigue the drummer limiting the time he/she can practice. Additionally, over time, the increased load transfer could act to break down and damage the joints and connective tissue in a drummer's hands, fingers and wrists.

To further supplement the strengthening of a drummer's fingers, hands, wrists and forearms, other devices have also been devised. Among these are the muscle control development system described in U.S. Pat. No. 5,744,737 which comprises several elastically deformable plastic elements that a drummer compresses in his/her hands to build strength.

U.S. Pat. No. 6,028,261 describes weights that are attached to drumsticks to increase the dynamic load of the drumsticks as they are swung, thereby acting to strengthen the user's forearms and hands. In general, since the weights are added to the stick in a particular location, the balance and particularly the center of gravity of the sticks are changed. Using weighted sticks with an altered center of gravity when practicing and warming up can negatively affect a drummer's drum play when he/she switches to unweighted sticks for a performance.

Finally, drumsticks made of aluminum are well known and have been available for decades. Aluminum sticks are typically either cast or turned on a lathe. The added mass of the aluminum sticks acts to strengthen a user's forearms and hands in essentially the same manner as wooden sticks that have weights added thereto, yet the stick is more evenly balanced as the additional mass is more uniformly distributed over the entire length of the stick. In other words, the aluminum sticks have a Cg similar to similarly shaped wooden sticks. Aluminum sticks are unsuitable for use with drums; however, since the added impact energy related to the sticks' added mass quickly damages and destroys the drum's skins. Accordingly, these sticks typically utilized with traditional drum practice pads.

As can be appreciated, the aforementioned problems related to the impact loads transferred to the drummer's hands and forearms when using a practice pad are further intensified when higher mass aluminum sticks are utilized. Accordingly, very few drummers use aluminum sticks during practice and those that do limit the total amount of time they use the aluminum sticks to avoid discomfort and potential injury.

### SUMMARY OF THE INVENTION

In one preferred embodiment, an apparatus for practicing drumming is described. The apparatus comprises a tensioned elastic cord suspended between and coupled to a pair of arms. The first pair of arms are coupled to one of a base and a stand.

In another preferred embodiment, another drumming practice apparatus is described. The apparatus comprises a bracket including at least two arms that are spaced apart from each other and a base portion wherein the base portion joins the two arms together. The apparatus also includes a tensioned cord that extends between the at least two arms and is attached to each of the at least two arms. At least one of an arm of the at least two arms and the tensioned cord is adapted to deform elastically and resiliently when the tensioned cord is struck with a drumstick.

In yet another preferred embodiment, a method of practicing drumming or playing a percussion instrument is described. The method comprises providing a tensioned cord; and repeatedly striking the cord with one or more drumsticks.

### SUMMARY OF THE DRAWINGS

FIG. 1 is an exploded isometric view of the first preferred embodiment of the present invention.

FIG. 2 is an isometric view of the first preferred embodiment of the present invention.

FIG. 3 is an isometric view of a second preferred embodiment of the present invention.

FIG. 4 is a rear isometric view of the second preferred embodiment of the present invention.

FIG. 5 is isometric view of a tensioning bracket as utilized in the first preferred embodiment of the present invention.

FIG. 6 is a top view of the tensioning bracket of the first preferred embodiment of the present invention.

FIGS. 7-10 illustrate various manner of striking of the first preferred embodiment of the present invention with drumsticks.

FIG. 11 illustrates a plurality of practice drumming devices supported on cymbal or drum stands according to a third preferred embodiment of the present invention.

FIG. 12 is an isometric view of the fourth preferred embodiment of the present invention.

FIG. 13 is an isometric view of the fifth preferred embodiment of the present invention.

FIG. 14 is an isometric view of the sixth preferred embodiment of the present invention.

FIG. 15 is a partial exploded isometric view of the sixth preferred embodiment showing the electronic pickup.

### DETAILED DESCRIPTION

One preferred embodiment of the current invention comprises one or more elastic straps (cords) which is tensioned and suspended between support bracketry. Optionally, in certain variations of the preferred embodiment, the bracketry is attached to a traditional practice pad. In other variations, the bracket can be attached to any suitable surface or device. For instance in one variation the bracket is adapted for attachment to a cymbal or drum stand.

When struck by a drumstick proximate the stick's end, the tensioned elastic cords resiliently deform temporarily storing the impact energy and then gently returning the energy as they spring back to their normal position. The energy returned quickly enough that the drummer will experience it as rebound similar to that experienced while striking a drum but because of the increased vertical movement of the cord compared with the vertical deformation of a rubber pad on a traditional practice pad, the absolute magnitude of the returned load will be relatively low.

Advantageously, striking preferred embodiments of the present invention with a drumstick provides a feel to the drummer comparable to striking a drum, yet does not fatigue the drummer or increase his/her risk of injury even when utilized with aluminum and weighted drumsticks. Additionally, depending on the configuration of the elastic cord(s), the sound made by the practice device when hit by a drumstick is substantially quieter than that of a drumstick hitting traditional practice pad. Certain variations make so little sound that a drummer can practice in the same room with others without being unordinarily disruptive to the others.

Numerous variations of the preferred embodiment drumming practice apparatus are contemplated. For instance, certain variations comprise a plurality of separately tensioned cords that can be arranged to approximate a configuration of a typical drumset. And in other variations, the tension of the cord(s) for a particular apparatus can be adjusted. In yet another variation an electronic pickup can be incorporated into the apparatus such that the user can plug device into an amplifier and utilize it as an electronic percussion device.

In an alternative embodiment of the present invention, a cord that isn't particularly elastic can be tautly suspended between two resilient bracket arms that elastically deform when the cord is struck by a drumstick. For instance, the bracket arms could comprise a thin generally rigid composite material or steel member that can withstand repeated cycles of elastic deformation without failing because of fatigue. In yet another alternative embodiment, the generally non-elastic cord could be suspended and biased at either end by a spring.

Given the foregoing examples of various variations of the preferred embodiment and several alternative embodiments, the advantages of the present invention and its various embodiments and the specific embodiments illustrated in described herein are not intended to be construed as limiting. Rather, numerous variations have been contemplated that read upon the appended claims and are intended to be within the scope of the invention.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases means that a particular feature, structure, or characteristic described in connection with the embodiment is included in at least an embodiment of the invention. The appearances of the phrase “in one embodiment” in various places in the specification are not necessarily all referring to the same embodiment.

The term “couple” or “coupled” as used in this specification and the appended claims refers to either an indirect or direct connection between the identified elements, components or objects. Often the manner of the coupling will be related specifically to the manner in which the two coupled elements interact. For example, a cord can be mechanically coupled to a bracket even if it is not physically touching the bracket if the elements are attached to one or more intervening elements.

The terms “apparatus” and “device” used interchangeably herein unless specifically indicated otherwise.

The term “cord” as used herein generally refers to any flexible elongated material or combination of materials that has a length that is one or more orders of magnitude greater than the material's width or diameter. Accordingly, “cord” includes, but is not limited to, rope, cable, wire, thread, bands and twine.

### A FIRST PREFERRED EMBODIMENT

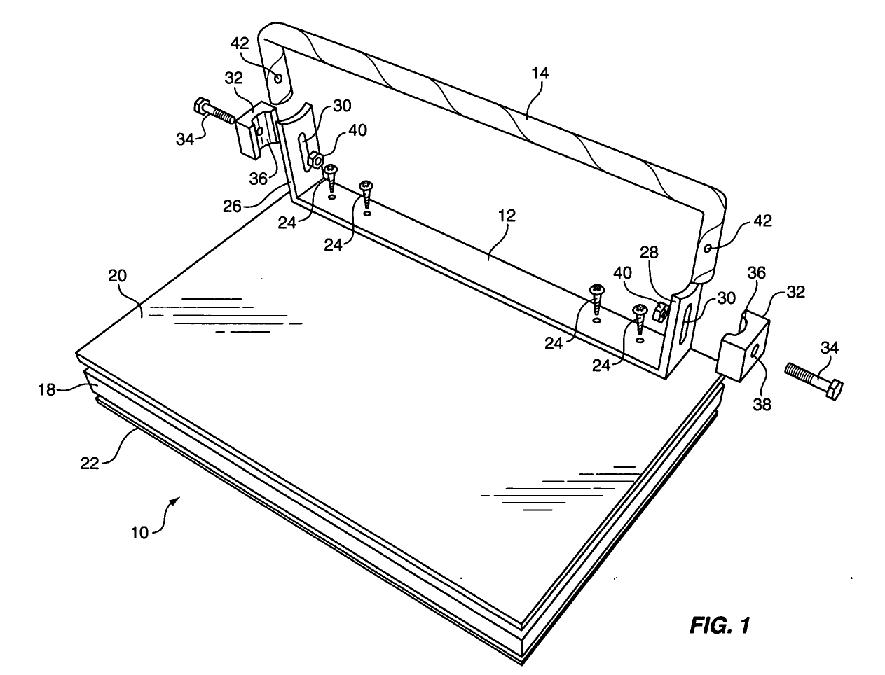

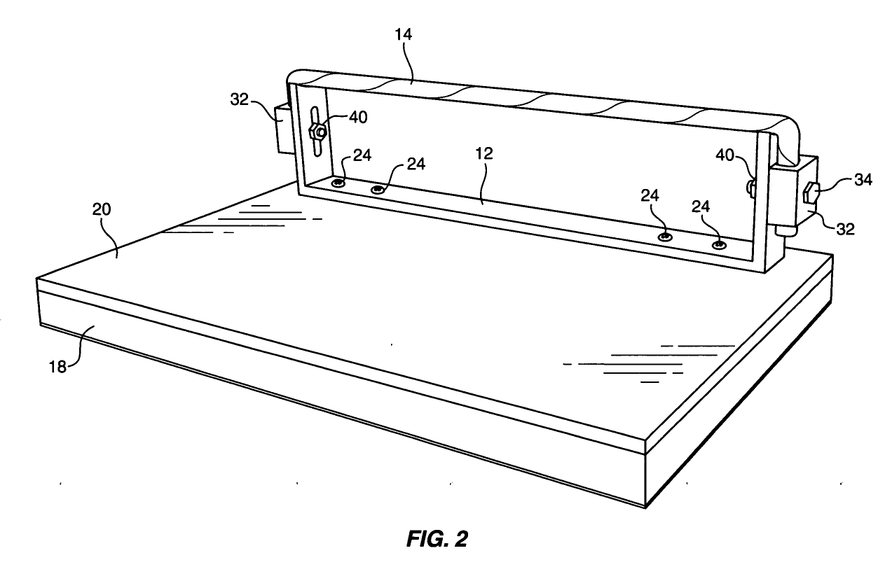

A first preferred embodiment of the present invention is illustrated in FIGS. 1 and 2. The first preferred embodiment comprises a rectangular traditional drum practice pad 10 with a U-shaped bracket (U-bracket) 12 attached to the top surface of the pad proximate one edge thereof. At least one elastic cord 14 (or band) is coupled to the vertical arms 26 & 28 of the bracket proximate the respective ends of the elastic cord wherein the elastic cord is tensioned.

The practice pad 10 illustrated herein is rectangular having a length and width each of between about 8 inches and 12 inches, although practice pads of other shapes and sizes can be utilized as well. A typical practice pad comprises wood core 18 that is approximately 0.5″ to 1.5″ thick sandwiched between a resilient rubber pad 20 of about 0.125″ to 0.375″ on the top and a thin non-skid pad 22 on the bottom that acts to both acoustically isolate the practice pad from the surface it is placed on, and keep the practice pad from slipping. The practice pad can vary substantially as would be obvious to someone of ordinary skill in the art. For instance, the wood core can comprise plastic or some other material; the non-skid pad can be replaced by support feet; and an elastomeric plastic or silicone elastomer can replace the rubber pad.

The U-shaped bracket 12 is fixedly and securely attached to the base typically with threaded fasteners 24 (four screws are illustrated) although any suitable manner of securing the bracket to the practice pad 10 is suitable. Typically, the bracket is made of steel but other materials can be utilized such as other metals, wood and reinforced or unreinforced plastic. In the preferred embodiment, the bracket is substantially stiff such that it does not flex or bend an appreciable amount when the elastic cord 14 is tensioned and when a drummer strikes the cord with a drumstick. It is to be appreciated that in variations of the preferred embodiment the bracket may comprise more than a single piece, such as two L-brackets that are independently attached to a practice pad or another base.

In the preferred embodiment, the respective left and right arms 26 & 28 of the U-shaped bracket 12 are about 2-4 inches tall, about ¾″ wide and about ⅛″ thick. A generally vertically orientated elongated slot 30 is provided in each arm for use in conjunction with a tensioning bracket 32 and an associated fastener 34 to facilitate the coupling of the ends of the elastic cord 14 to the U-bracket.

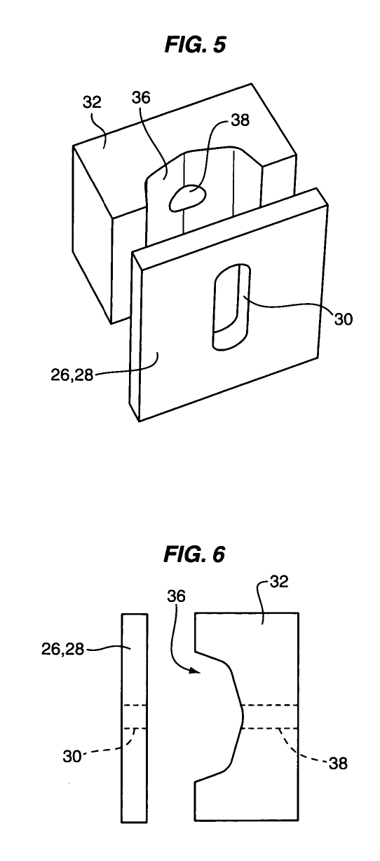

Referring to FIGS. 5 and 6, the tensioning bracket 32 is illustrated. The tensioning bracket is preferably made of aluminum or steel although other suitable materials can be utilized as well. Typically, the tensioning bracket includes a vertically orientated groove 36 that has a cross sectional area less than the corresponding cross sectional area of an elastic cord 14 (or cords) to be received therein. The bracket also includes a bore 38 that extends therethrough and is adapted to be aligned with the slot 30 of a corresponding arm of the U-bracket 12. Accordingly, when the end of a elastic cord is placed in the groove and the tensioning bracket is tightened against the corresponding arm 26 & 28 by way of a fastener 34 that passes through both the tensioning bracket's bore and the arm's slot and its corresponding nut 40, the elastic cord is effectively clamped in place to (i) prevent its longitudinal movement, and (ii) hold the cord in tension.

The elastic cord 14 can comprise any suitable elastomeric material having the strength, resiliency and resistance to creep to withstand being held in constant tension and to withstand repeated, rapid and high cycle impact of a drum stick against it. As can be appreciated, the longitudinal elastic modulus of the chosen cord in combination with the amount of tension applied to the cord will greatly affect the response characteristics of the preferred embodiment practice device when it is stuck with a drum stick. Accordingly, different types of cords set at differing tensions can be utilized by a drummer depending on his/her personal preferences and the particular type of drum he/she is interested in most closely simulating. One type of cord that has been found to be suitable for application in the drumming practice device is a bungee-type cord that comprises a plurality of rubber filaments encased in a typically nylon braided fabric sleeve. A single bungee cord can be utilized in combination with a single U-bracket 12 or in other variations two or more smaller bungee-type cords can be utilized in conjunction with a single U-bracket.

Referring primarily to FIG. 1, the use of slotted vertical arms 26 & 28 in the U-bracket 12 permits a drummer to easily adjust the tension of the elastic cord 14 to a level that best suits his/her desires. In the preferred embodiment, the elastic cord includes holes 42 passing through it proximate each end through which the fasteners 34 can pass when the cord is received into the grooves 36 of the tensioning brackets 32. Accordingly, to adjust the tension of the elastic cord, a drummer first loosens the nut 40 of one of the fasteners and moves the associated tensioning bracket, fastener and elastic cord combination upwardly or downwardly depending on whether he/she desires to increase or decrease the amount of tension. It has been found that about 10 to 80 pounds of tension, and more preferably 20-40 pounds of tension, is suitable tension when using a bungee type elastic cord with the first preferred embodiment.

In variations of the preferred embodiment and in alternative embodiments, different means of (i) fastening the cord 14 to the arms 26 & 28, and (ii) adjusting the tension of the cord can be provided. For example, the elastic cord can be independently clamped or otherwise secured to a tensioning bracket assembly with the bracket then attaching to the associated U-bracket arm via a fastener received in the arm's slot. In yet another example, a ratcheting reel can be attached to one arm wherein a user can tighten or loosen an elastic cord by either winding or unwinding it from the reel.

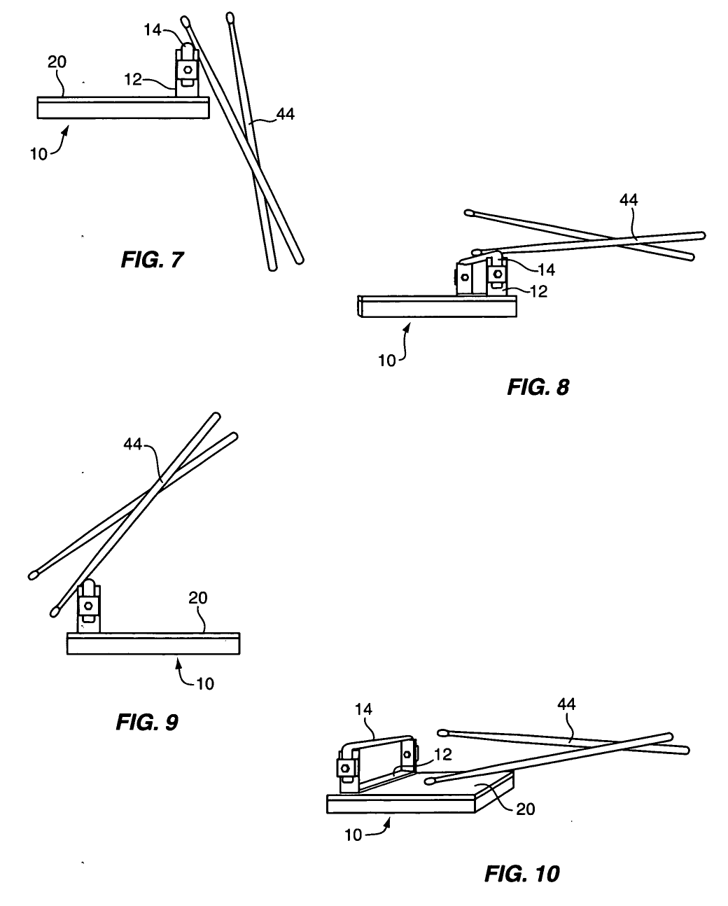

Referring to FIGS. 7 through 10, a variety of different ways in which a drummer can use the first preferred embodiment of the drumming practice apparatus are illustrated. FIGS. 7 and 9 show the sticks 44 hitting the elastic cord 14 at an oblique angle and would correspond to performing in a seated position with the device slightly above navel level, or standing with the device at about mid-thigh level. FIG. 8 shows the sticks hitting the cord at about parallel position, and FIG. 10 shows the sticks hitting the resilient pad surface 20 instead of the elastic cord in manner similar to that used in conjunction with prior art practice pads. It is appreciated that each of these methods exercises a drummer's muscles in a slightly different manner.

### A SECOND PREFERRED EMBODIMENT

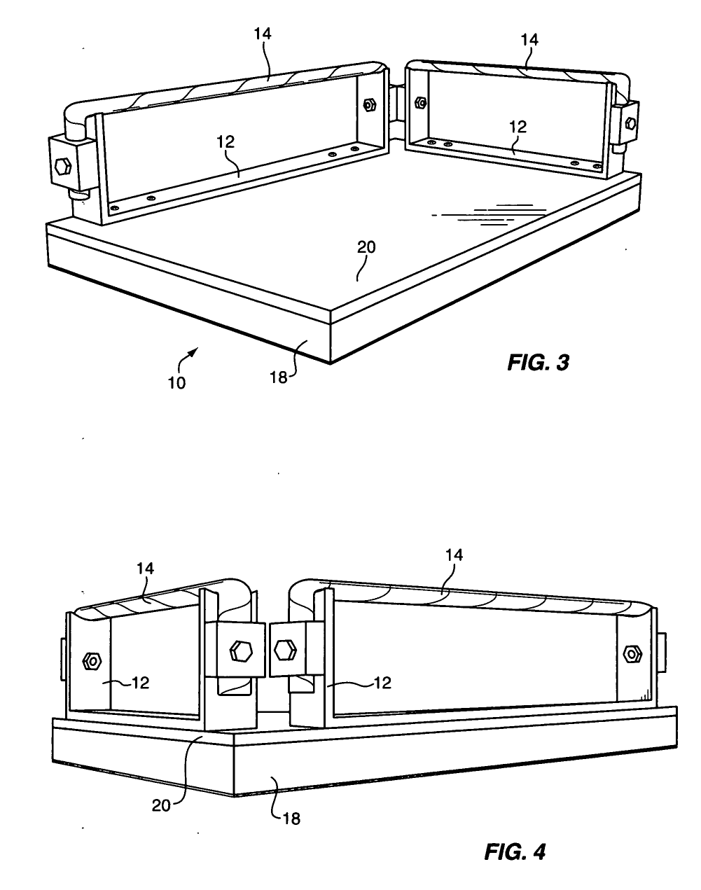

Referring to FIGS. 3 and 4, a second preferred embodiment of the present invention is illustrated. Generally, the second preferred embodiment is similar to the first preferred embodiment except for the addition of a second U-bracket 12 and elastic cord 14 combination that is attached to the top of the practice pad 10 adjacent the first U-bracket and elastic cord combination. This configuration permits a drummer to vary his/her practice routine incorporating more movement of the drummer's arms as he/she switches between the two elastic cords. This combination permits the drummer to practice in a manner more representative of drumming using a multi-headed drumset. It is to be appreciated that while the two tensioned elastic cords are illustrated as being in relative close proximity to each other, the actual distance between the tensioned cords and their angles relative to each other can vary substantially depending on the size of the practice pad or other suitable base member.

### A THIRD PREFERRED EMBODIMENT

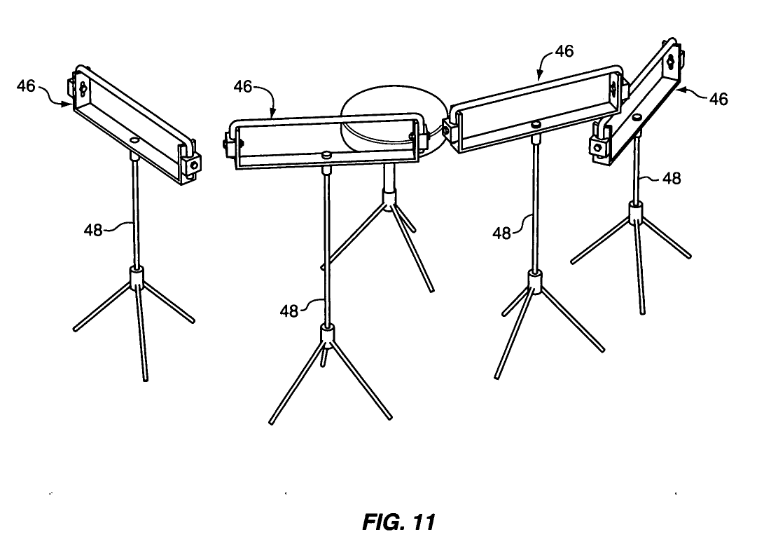

Referring to FIG. 11, a third preferred embodiment of the present invention is illustrated that comprises a plurality of tensioned elastic cord and U-bracket assemblies 46 attached to drum or cymbal stands 48 and arranged in a manner to simulate an arrangement of drums in a multi-piece drum set. Even more so than the second preferred embodiment, this embodiment permits a drummer to incorporate arm and upper body movement into his/her drumming practice workout. Because the cymbal and/or drum stands to which the U-bracket and tensioned cord assemblies are attached are typically height adjustable, the relative heights of the tensioned cords can vary as well for additional workout variety.

### A FOURTH PREFERRED EMBODIMENT

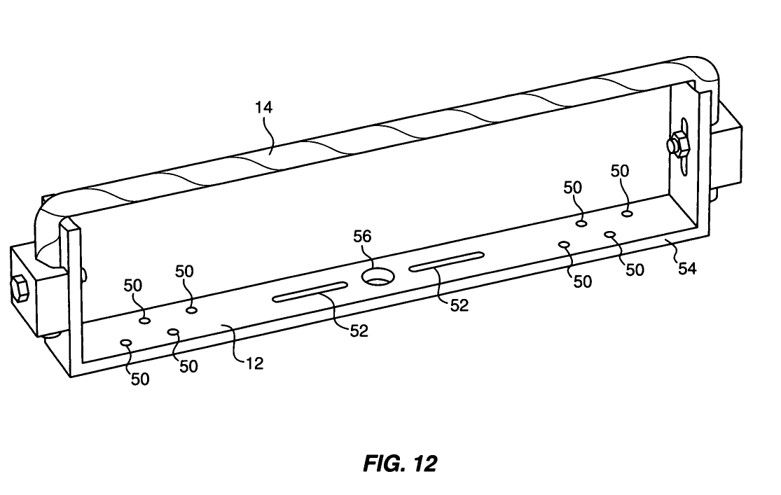

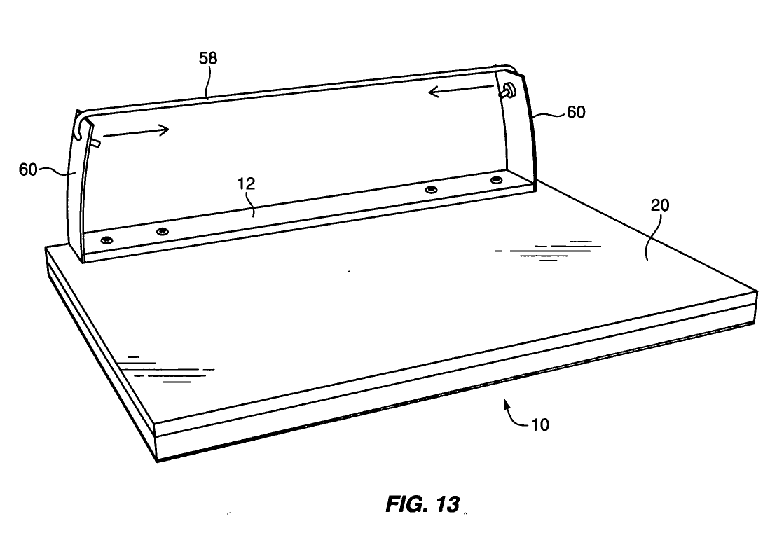

Referring to FIG. 12, a fourth preferred embodiment of the present invention is illustrated. Essentially this preferred embodiment comprises the tensioned elastic cord 14 and U-bracket 12 of all the previous described preferred embodiments sans any base or stand. Further, additional bores 50 and/or slots 52 are provided in the base portion 54 of the U-bracket typically including a bore 56 centered on the bracket for attachment to a cymbal or drum stand 48. Accordingly, a drummer can attach this embodiment to any suitable stand or surface as he/she desires. For instance, a drummer may buy the fourth preferred embodiment and attach it to a practice pad he/she already owns using suitable fasteners. Alternatively, he/she may attach this embodiment to a simple wood base, or perhaps he/she may attach the unit to a cymbal stand he/she already has. In another variation, a clamp (not shown) can be provided so a drummer can removably attach the device to a table or desk.

### A FIFTH PREFERRED EMBODIMENT

The fifth preferred embodiment as shown in FIG. 13 differs from the other previously described embodiments in that the substantially elastic cord is replaced by a generally inelastic cord 58, such as but not limited steel cable or nylon filament, and the substantially rigid arms of the U-bracket are replaced by more flexible arms 60 that give or deform elastically when the cord is struck by a drum stick. In other words, the arms are flat springs. Further, the arms will act when the cord is secured and tightened in place to bias the cord and hold it at the desired amount of tension. Essentially, this embodiment offers similar advantageous as the previous preferred embodiments but incorporates the resiliency of the present invention in the arms of the bracket instead of in the cord itself. Preferably, the arms can be made of spring steel that is substantially thinner than the arms of the first preferred embodiment, or the arms could be made of a fiberglass or graphite fiber reinforced composite material that is fatigue resistant. Other materials can be used as well provided they are resistant to fatigue at the load levels induced on the arms by the repeated striking of the associated cord with drumsticks.

In a variation of the fifth preferred embodiment, the generally inelastic cord 58 can be used in combination with substantially rigid U-bracket arms wherein the one or both ends of the cord are coupled to the arms by way of one or more springs (not shown). Accordingly, the cord is biased in tension by the spring(s) and the spring(s) give when the cord is struck by a drumstick to more evenly distribute the impact load associated with the strike.

### A SIXTH PREFERRED EMBODIMENT

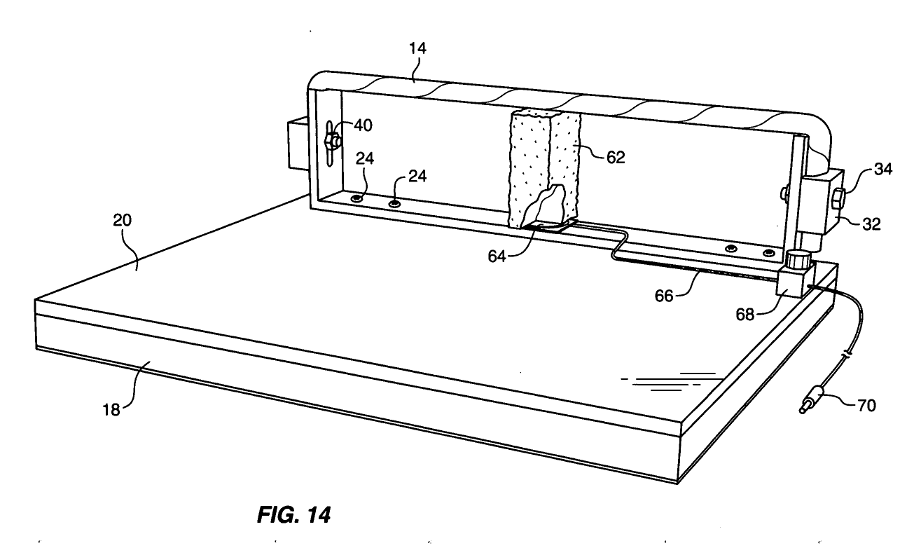

The sixth preferred embodiment as illustrated in FIG. 14 differs from the others embodiments in that it incorporates an electronic pickup that transforms the apparatus from simply a quiet practice device to a new type of electronic percussion instrument that can be utilized in place of a drum or in combination with other percussion instruments. Essentially, the apparatus used in this embodiment can be similar to that of the first, fourth or fifth embodiment except for the addition of the electronic pickup. Simply the electronic pickup generates a signal that is proportional to the load and/or deflection of the cord 14 when struck that is sent to an associated MIDI drum controller (not shown) or other synthesizer. The controller then transforms the signal into a particular sound depending on the controller's programming or setup. In other words, based on the MIDI controller's programming, the apparatus of the sixth preferred embodiment can be made to sound similar to any percussion type of drum or other percussion device. Further, the apparatus in conjunction with the controller can be made to produce sound unlike any other non-electronic traditional percussion device.

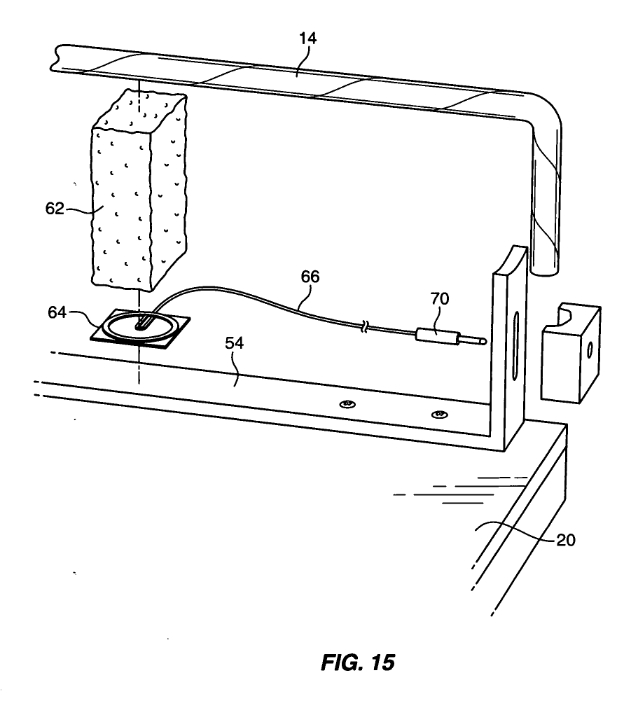

An exploded view of one type of suitable pickup is shown in an exploded view in FIG. 15. The pickup comprises (1) a foam pad 62 that is positioned underneath the elastic cord 14 and attached thereto; (2) a flat piezoelectric crystal 64 that is secured between a base, such as the practice pad 10 of the first preferred embodiment or even the base portion 54 of the U-shaped bracket (as shown), and the bottom side of the foam pad; (3) a potentiometer 68 connected to the crystal through a wire 66 or other electrical trace for conditioning the voltage output from the crystal to a level suitable for input into the controller; and an input jack 70, such as a typical ¼″ phono-jack.

The foam 62 can be of any suitable type and acts primarily to transfer a portion of the load imparted to the elastic cord 14 through it to the piezoelectric crystal 64. Ultimately, the density and stiffness of the foam should be high enough that a sufficient load is transferred to the piezoelectric crystal but no so high that it would significantly affect the manner in which the tensioned cord deflects when struck with a drumstick. High density polyurethane foam of the type commonly used for seat cushions and similar applications has been found to be suitable for the sixth preferred embodiment.

Depending on the magnitude of the load incident on the crystal 64, a voltage is produced within the crystal that is sent to the controller. The controller interprets the voltage to produce a desired sound of a particular volume relative to the magnitude of the voltage received. One piezoelectric crystal found to be suitable for this application is a flat circular crystal part no. 900-1401 purchased at Radio Shack. Of course, many other different crystals are suitable for this application. Ideally, a combination of foam 62 and a crystal is chosen so that each amount of impact that a drummer strikes the tensioned cord with will result in a different voltage being generated in the crystal causing in a different loudness level to be output by the controller. In other words, when the drummer strikes the tensioned cord with a greater force, the resulting output will be louder than when the drummer strikes the tensioned cord with a lesser impact force.

Many other alternative types of pickup devices can be used in conjunction with the present invention and the invention is in no way intended to be limited to the single type of pickup mechanism specifically described herein. For example, a pickup that senses displacement or vibration could be attached directly to the flexing arm of the bracket in the fifth preferred embodiment apparatus. In other variations, a pickup can be attached directly to the elastic or inelastic cord. Further, the pickup need not be based on piezoelectric technology wherein the pickup generates a small electrical current when subject to a load. Rather, a sensor akin to a strain gauge can also be utilized wherein the electrical resistance of the sensor changes relative to changes in length to something to which it is attached, such as the elastic cord.

### ALTERNATIVE EMBODIMENTS AND OTHER VARIATIONS

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention. For example, although several of the preferred embodiments are illustrated as being attached to a standard prior art type drumming practice pad, in variations and alternative embodiments thereof, the practice pad could be replaced with any suitable board made of any suitable material.

1. An apparatus for practicing drumming comprising a tensioned first elastic cord suspended between and coupled to a first pair of arms, the first pair of arms coupled to one of a base and a stand.

2. The apparatus of claim 1, wherein the first pair of arms and a base portion spanning between the first pair of arms comprise a generally U-shaped bracket.

3. The apparatus of claim 1, wherein the first pair of arms are coupled to the base and the base comprises a drumming practice pad.

4. The apparatus of claim 2, wherein the first pair of arms extend substantially perpendicularly from the base portion.

5. The apparatus of claim 1, wherein the suspended elastic cord comprises at least one multi-filament elastomeric cord at least partially covered by a fabric sleeve.

6. The apparatus of claim 1, wherein the tension of the elastic cord is user adjustable.

8. The apparatus of claim 1, further comprising a tensioning mechanism adapted to selectively adjust a level of tension in the first elastic cord.

9. The apparatus of claim 1, wherein the first pair of arms are spaced from each other a distance of about 10-12 inches.

10. An apparatus of claim 1, further comprising a second pair of arms and a second tensioned elastic cord, the tensioned second elastic cord being suspended from the second pair of arms, the second pair of arms being attached to one of the base and the stand.

11. A drumming practice apparatus comprising:
a bracket including at least two arms spaced apart from each other and a base portion, the base portion joining the two arms together; and
a tensioned cord, the tensioned cord extending between the at least two arms and being attached to each of the at least two arms;
wherein at least one of (i) an arm of the at least two arms and (ii) the tensioned cord is adapted to deform elastically and resiliently when the tensioned cord is struck with a drumstick.

12. The drumming practice apparatus of claim 11, wherein the bracket comprises a unitary U-shaped bracket.

13. The drumming apparatus of claim 11, wherein the tensioned cord comprises an elastic cord that is adapted to stretch when impacted by a drumstick.

14. A combination comprising a plurality of drumming practice apparatus of claim 11, wherein each drumming apparatus is coupled to a stand and is arranged in a configuration to approximate the configuration of a drumset.

15. The drumming apparatus of claim 11, further comprising an electron pickup.

16. The drumming apparatus of claim 11, wherein the base portion further includes one or both of a plurality of bores and slots extending therethrough, The bores and slots being adapted to receive a fastener to secure the drumming apparatus to a surface.

17. A method comprising:
providing a tensioned cord; and
repeatedly striking the cord with one or more drumsticks.

18. The method of claim 17, wherein at least one of the one or more drumsticks comprises aluminum.

19. The method of claim 17, wherein the tensioned cord is at least one of: (i) an elastic cord; and (ii) operatively coupled to a biasing spring member.

20. The method of claim 17, wherein said repeatedly striking the cord with one or more drumsticks further practicing the rudiments of drumming.
